(19) United States
(12) Patent Application Publication
(10) Pub. No.: US 2009/0000490 A1
(43) Pub. Date: Jan. 1, 2009

(54) GRIDDLER APPARATUS

(76) Inventor: CHARLES Z. KRASZNAI, Bridgeport, CT (US)

Correspondence Address: Lawrence Cruz;Conair Corporation, One Cummings Point Road, STAMFORD, CT, 06902, US

(21) Appl. No.: 12/131,497

(22) Filed: Jun. 2, 2008

Related U.S. Application Data
(60) Provisional application No. 60/932,696, filed on Jun. 1, 2007.

(51) Int. Cl. A47J 37/06

(52) U.S. Cl. 99/376

(57) ABSTRACT

A griddler apparatus includes a base (12) and a cover (24) with the base (12) and the cover (24) adapted for relative movement between an open position and a closed position, bottom and top grill plates (16, 30) respectively mounted to the base (12) and the cover (24) and having cooperating cooking surfaces adapted to grill a food product therebetween when the base (12) and the cover (24) are in the closed position, bottom and top heaters (18) associated with the bottom and top grill plates (16, 30) for providing heat to the bottom and top grill plates and a single temperature control (20). The single temperature control (20) controls the temperature of the bottom and top heaters (40).

### BACKGROUND

1. Technical Field

The present disclosure generally relates to be cooking appliances and, in particular, relates to a griddler apparatus for preparing a variety of food products.

2. Discussion of Related Art

Grills, and in particular electric grills, are known. These devices are generally constructed with heating plates having a particular surface geometry for heating food placed thereon. The heating plates may be secured to a housing and heated by an electrical resistance heater. An example of a grill apparatus is disclosed in commonly assigned U.S. Pat. No. 7,109,442 to Steinberg, the entire contents of which are hereby incorporated by reference herein.

### SUMMARY

Accordingly, the present disclosure is directed to further improvements in grilling apparatuses. In one embodiment of the present disclosure, a griddler apparatus includes a base and a cover with the base and the cover adapted for relative movement between an open position and a closed position, bottom and top grill plates respectively mounted to the base and the cover and having cooperating cooking surfaces adapted to grill a food product therebetween when the base and the cover are in the closed position, bottom and top heaters associated with the bottom and top grill plates for providing heat to the bottom and top grill plates and a single temperature control knob. The single temperature control knob controls the temperature of both the bottom and the top heaters. At least one of the bottom and top grill plates may be releasably mounted relative to the respective base and the cover. Preferably, each of the bottom and top grill plates are releasably mounted to the respective base and the cover. A release member may be in operative engagement with the one of the bottom and the top grill plates. The release member is adapted for movement between a locked position securing the one of the bottom and the top grill plates, and a release position releasing the one of the bottom and the top grill plates to permit removal thereof. The bottom and top grill plates may include recesses to accommodate the respective heaters. Other features will be made readily apparent from the following description.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiment(s) given below, serve to explain the principles of the disclosure, wherein

FIG. 1 is a perspective view of a griddler apparatus in accordance with the principles of the present disclosure in a closed position;

FIG. 2 is a perspective view of the griddler apparatus in an open position;

FIG. 3 is a side plan view of the griddler apparatus;

FIG. 4 is a perspective view with parts separated of the griddler apparatus;

FIG. 5 is a schematic view illustrating the release member for releasably securing the grill plates to their respective housings; and

FIG. 6 is a schematic circuit diagram.

### DETAILED DESCRIPTION

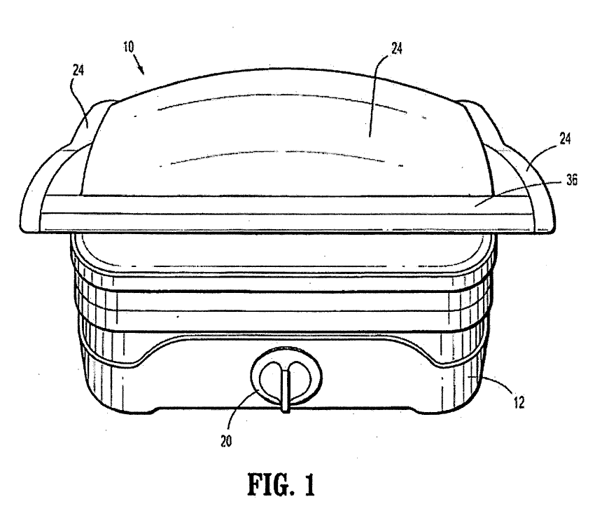

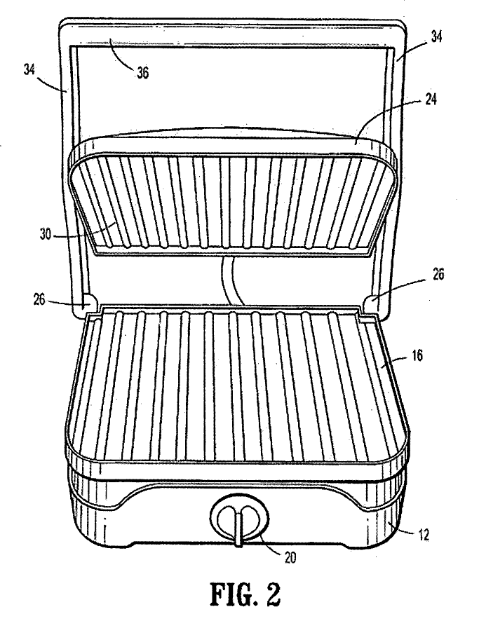

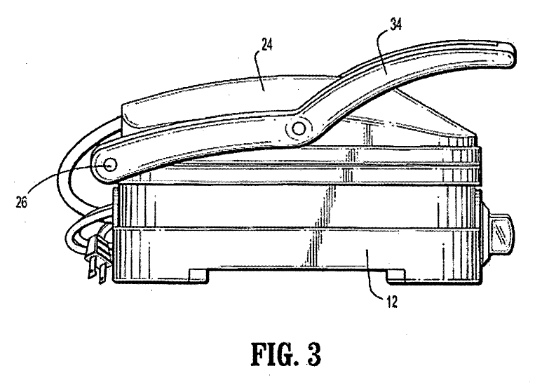

Referring now to FIGS. 1-6, the griddler apparatus in accordance with the principles of the present disclosure is illustrated. Griddler apparatus 10 is preferably a portable unit adapted for positioning on a support surface such as a table, countertop or the like. Griddler apparatus 10 includes base 12 having bottom reflector 14 and bottom grill plate 16. Nested within bottom grill plate 16 is resistive heater 18 which preferably is housed within a correspondingly dimensioned groove 19 defined within the lower surface of the bottom grill plate 16. Heater or coil 18 is preferably a resistive heating element known in the art. Base 12 has temperature control 20 mounted to its outer surface and in electrical communication with heater 18 to vary the temperature of the heater and grill plate 16. Base 12 may incorporate four legs 22 at each corner to elevate base 12 from the support surface.

Griddler apparatus 10 further includes top cover 24 which is pivotally mounted to base through hinges 26. Top cover 24 includes top reflector 28, top grill plate 30 and heater 32 disposed between the reflector 28 and the top grill plate 30. Heater 32 is also controlled through temperature control knob 20. Top cover 24 includes opposed arms 34 on each side of the cover 24 to enable the user to pivot top cover 24 between an open position and a closed position. Arms 34 may be interconnected via handle 36 extending across the front of top cover 24 whereby the handle 36 may be engaged to open and close the top cover.

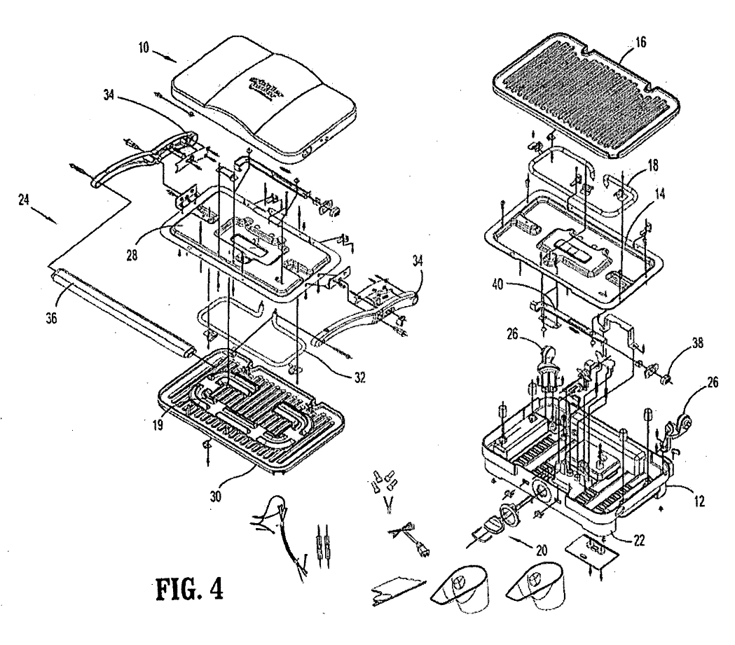

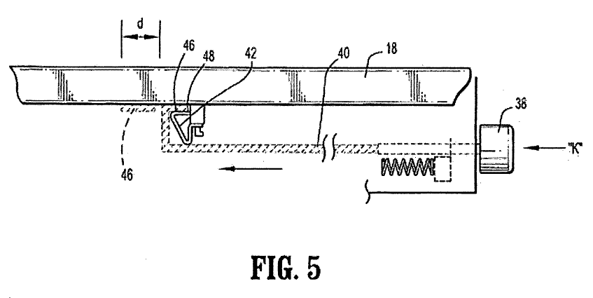

Release mechanisms for releasably securing bottom and top grill plates 16, 30 may be provided. The release mechanisms may include a button actuator 38 which is actuated to release a respective plate 16, 30 for cleaning purposes. One release mechanism suitable for use with apparatus 10 is disclosed in commonly assigned U.S. Pat. No. 7,109,442 to Steinberg et al., the entire contents of which are incorporated herein by reference. In one embodiment best depicted in FIGS. 4 and 5, button actuators 38 are operatively connected to release plates 40 which engage corresponding structure on the grill plates 16, 30 or structure connected to or associated with the grill plates 16, 30 to release the grill plates 16, 30 upon depression of the button actuators 38. In one embodiment, release plates 40 engage plate lockers 42 affixed to the external surfaces of grill plates 16, 30. Button actuators 34 may be spring biased to an outward or locked position through conventional spring means 44. In the locked position of button actuators 38, ledge 46 of release plate 40 is received within locking recess 48 of plate locker 42. Locking recess 48 may be the gap defined between plate locker 42 and the lower surface of grill plate 16 or the upper surface of grill plate 30. In the release position, i.e., when button actuator 34 is depressed inwardly in the direction of arrow “k”, release plate 40 travels a predetermined distance “d” which displaces ledge 46 from locking recess 48 (shown in phantom in FIG. 5) thus releasing the ledge 46 and permitting removal of either grill plate 16, 30.

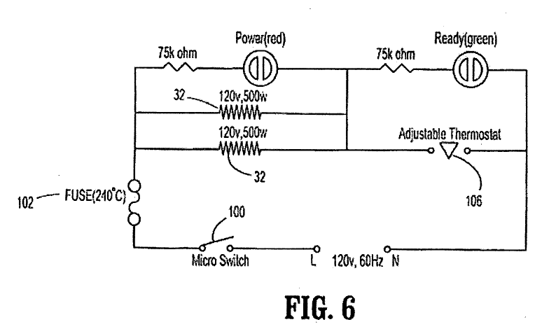

FIG. 6 is a circuit diagram of the electrical components of apparatus 10. The electrical components may include switch 100, fuse 102, heaters 32 and thermostat 106 associated with temperature control knob 20.

In use, top cover 24 is pivoted upwardly to an open position to permit placement of the food product onto bottom grill plate 16. The system is activated and the temperatures of grill plates 16, 30 are controlled via temperature control 20. Top cover 24 may be pivoted downwardly onto the food product such that the food product is cooked between the top and bottom grill plates 16, 30. Grill plates 16, 30 may have raised ribs a shown or may be smooth.

While the invention has been particularly shown, and described with reference to the preferred embodiments, it will be understood by those skilled in the art that various modifications and changes in form and detail may be made therein without departing from the scope and spirit of the invention. Accordingly, modifications such as those suggested above, but not limited thereto, are to be considered within the scope of the invention.

What is claimed is:

1. A griddler apparatus, which comprises:
a base and a cover, the base and the cover adapted for relative movement between an open position and a closed position;
bottom and top grill plates respectively mounted to the base and the cover, the bottom and top grill plates having cooperating cooking surfaces adapted to grill a food product therebetween when the base and the cover are in the closed position; and
bottom and top heaters associated with the bottom and top grill plates for providing heat to the bottom and top grill plates; and
a single temperature control for controlling the temperature of the bottom and top heaters.

2. The griddler apparatus according to claim 1 wherein at least one of the bottom and top grill plates is releasably mounted relative to the respective base and the cover.

3. The griddler apparatus according to claim 2 each of the bottom and top grill plates are releasably mounted to the respective base and the cover.

4. The cooking apparatus according to claim 2 including a release member in operative engagement with the one of the bottom and the top grill plates, the release member adapted for movement between a locked position securing the one of the bottom and the top grill plates, and a release position releasing the one of the bottom and the top grill plates to permit removal thereof.

5. The cooking apparatus according to claim 3 wherein the bottom and top grill plates include recesses to accommodate the respective heaters.
